(19) United States
(12) Patent Application Publication
(10) Pub. No.: US 2009/0298029 A1
(43) Pub. Date: Dec. 3, 2009

(54) LEARNING SHOES

(76) Inventors: JANIE WILDER, Las Vegas, NV (US); MITCHELL A. WILDER, Las Vegas, NV (US)

Correspondence Address: James Ray & Associates, 2640 Pitcairn Road, Monroeville, PA, 15146, US

(21) Appl. No.: 12/436,866

(22) Filed: May 7, 2009

Related U.S. Application Data
(60) Provisional application No. 61/130,899, filed on Jun. 3, 2008.

(51) Int. Cl. G09B 19/24

(52) U.S. Cl. 434/260

(57) ABSTRACT

An apparatus for providing a learning tool for teaching children with special needs the art of tying shoes as a means of therapy that a learning process offers, the apparatus comprises a housing member having a predetermined shape, a predetermined size and formed of a predetermined material. A pair of shoes are disposed on an upper surface of the housing member in a predetermined orientation. There are two sets of laces disposed on each shoe of the pair of shoes in a predetermined manner, such each of such two sets of laces having a different predetermined color.

### CROSS REFERENCE TO RELATED APPLICATIONS

This application is closely related to and claims benefit from U.S. Provisional Application Ser. No. 61/130,899 filed May 30, 2008.

### FIELD OF THE INVENTION

The present invention relates, in general, to an apparatus for teaching a child how to tie shoes, and, more particularly, the present invention relates to an apparatus for use with special needs children in assisting them by trying to tie the laces on shoes as a learning process.

### BACKGROUND OF THE INVENTION

Many special needs children have difficulty doing what is considered relatively simple chores. Tying the laces on shoes would be an example of this. It is not only the tying of the laces that provides the child with a sense of achievement and the skill is of value to the handicapped child but one of the primary purposes of such an endeavor is the therapy that the learning process offers.

Thus, it would be advantageous if there were a simple and relatively inexpensive means that would enable special needs children to learn to tie the laces on shoes as a learning process.

### SUMMARY OF THE INVENTION

In a first aspect the present invention provides an apparatus for providing a learning tool for teaching children with special needs the art of tying shoes as a means of therapy that a learning process offers, the apparatus comprises a housing member having a predetermined shape, a predetermined size and formed of a predetermined material. A pair of shoes are disposed on an upper surface of the housing member in a predetermined orientation. There are two sets of laces disposed on each shoe of the pair of shoes in a predetermined manner, such each of such two sets of laces having a different predetermined color.

### OBJECTS OF THE INVENTION

It is, therefore, one of the primary objects of the present invention to provide an apparatus for assisting in teaching a child with special needs the art of tying shoes.

Another object of the present invention is to provide an apparatus which is used in the therapy for special needs children that the learning process offers.

Still another object of the present invention is to provide an apparatus that helps special needs children focus on a task.

Yet another object of the present invention is to provide an apparatus that helps special needs children with manual dexterity.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of the apparatus according to an embodiment of the invention showing the pair of shoes disposed on top of the housing member.

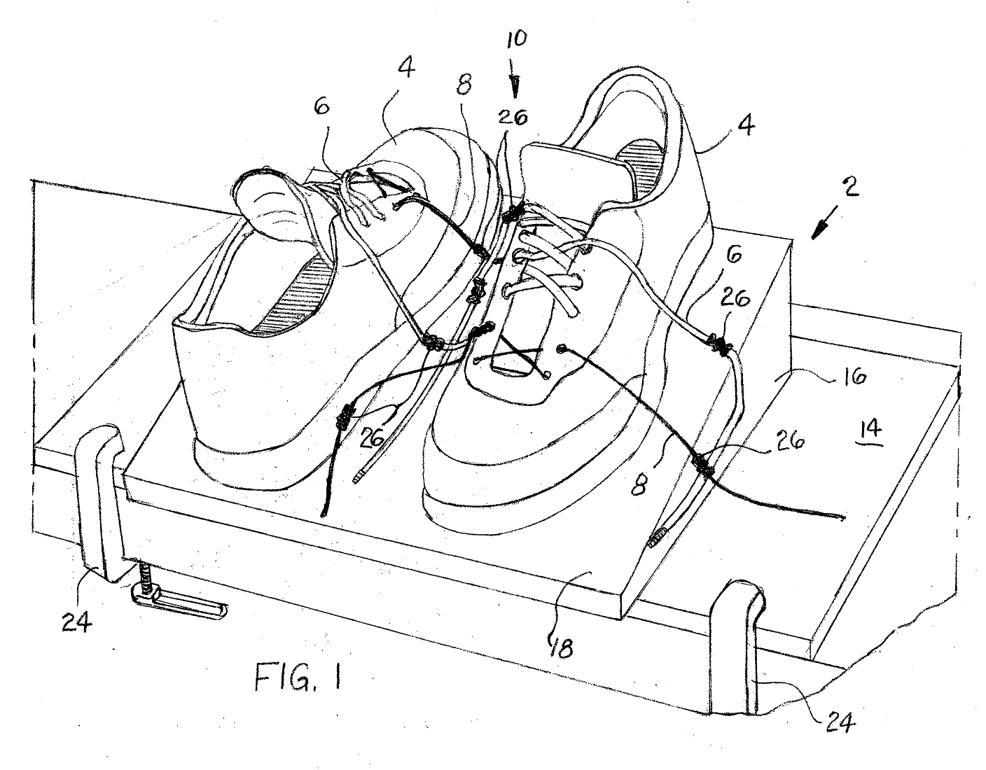

FIG. 2 is a top perspective view of the apparatus shown in FIG. 1 showing a closeup of one of the shoes.

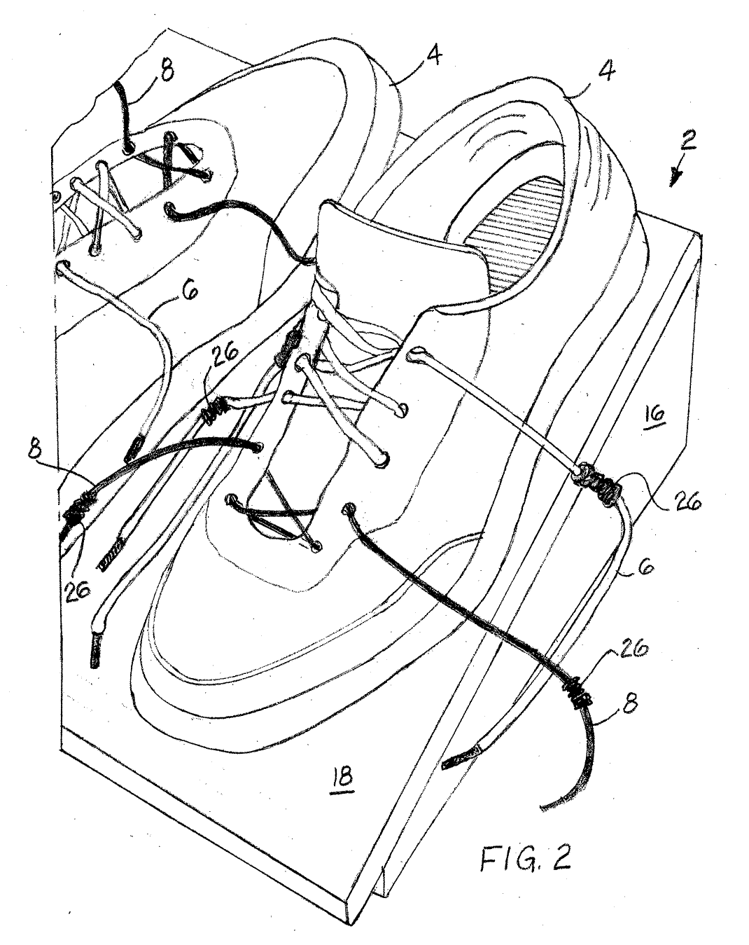

FIG. 3 is a side perspective view of the apparatus shown in FIG. 1 showing a special needs child grasping a pair of laces.

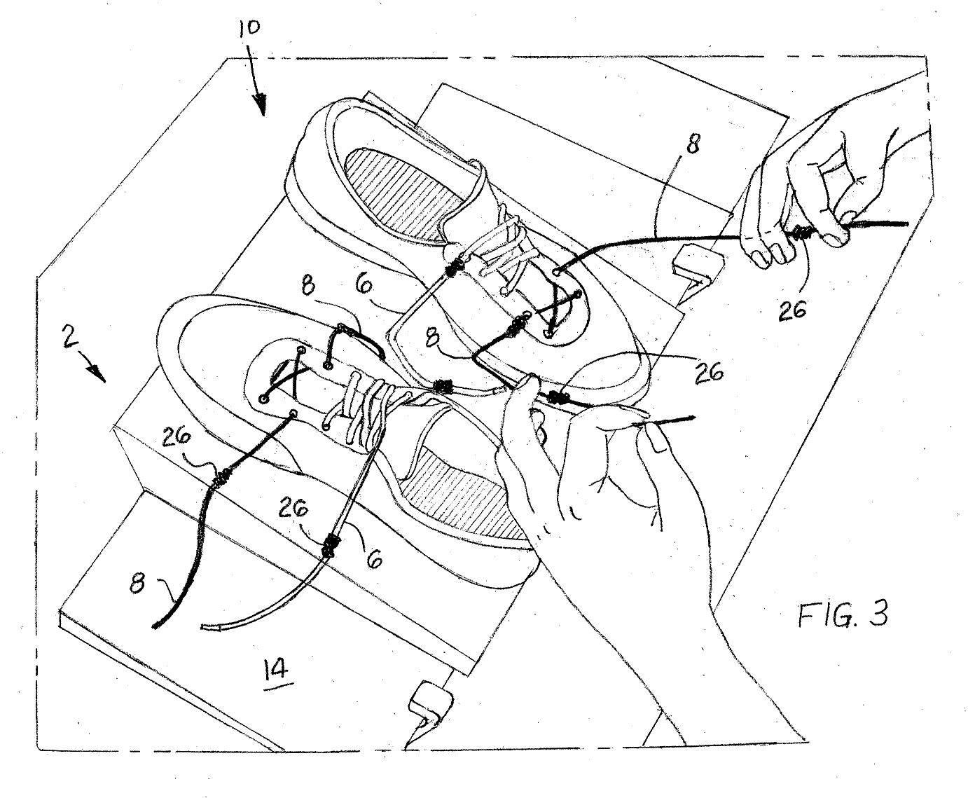

FIG. 4 is a back perspective view of the apparatus shown in FIG. 1 showing the storage compartment.

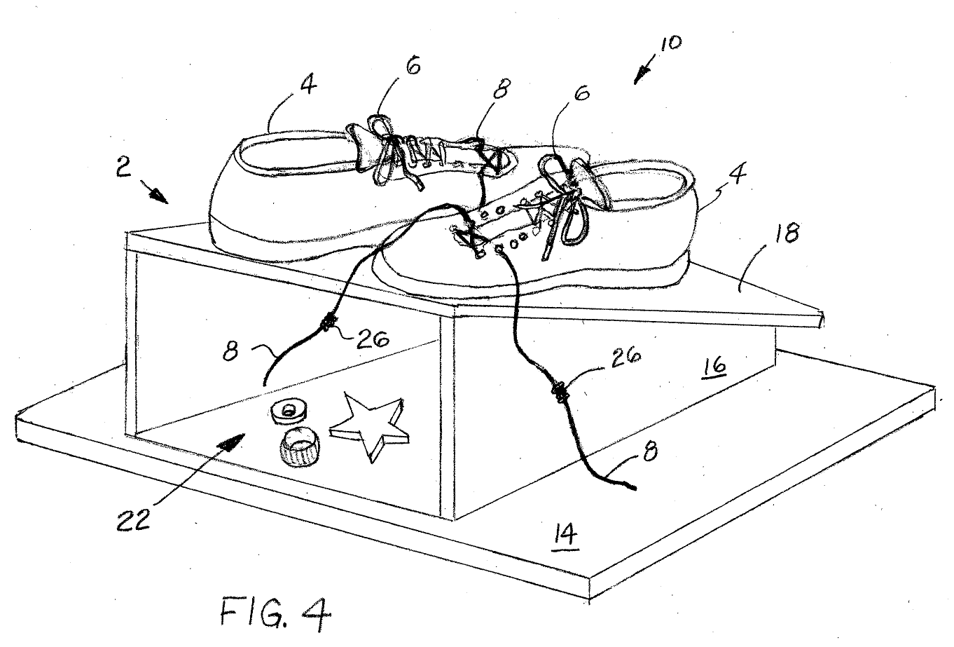

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing a learning tool for teaching children with special needs the art of tying shoes as a means of therapy that the learning process offers. The apparatus 10 comprises a housing member 2 having a predetermined shape, a predetermined size and formed of a predetermined material. A pair of shoes 4 are disposed on an upper surface of the housing member 2 in a predetermined orientation. There are two sets of laces 6,8 disposed on each shoe 4 of the pair of shoes 4 in a predetermined manner, such each of such two sets of laces 6,8 having a different predetermined color.

Such laces 6,8 further include rubber bands 12 disposed on each lace of said two sets of laces 6,8 at predetermined positions as least for a target for such child to grasp such lace. The two sets of laces 6,8 provide a means of repeating such art of tying the laces without undoing a completed task.

Such housing member 2 includes a substantially flat base member 14, a pair of triangular shaped side members 16 engageable on a bottom portion thereof with the upper surface of the substantially flat base member 14 and a top member 18 affixed to such triangular shaped side members 16 so that the top portion 18 is set at a predetermined angle. Such housing member 2 further includes an open compartment 22 disposed between an underside of the top portion 18, inside surfaces of such side members 16 and an upper surface of such base member 14. Such open compartment 22 is used to store of prizes and/or awards for accomplishing a given task.

It is presently preferred that such predetermined material for forming the housing member 2 is selected from one of wood and plastic.

Such substantially flat base member 13 is made to extend beyond the triangular shaped side members 16 when forming the housing. Such apparatus further includes a pair of clamps 24 for securing the apparatus to a predetermined object. Such clamps 24 are engageable with the portion of the substantially flat base member 14 that extends beyond the triangular side members 16.

Each lace of the two sets of laces 6,8 further include rubber bands 24 disposed at predetermined positions on such each lace for assisting such special needs child in knowing where to grasp such each lace.

It should be noted that the present apparatus is not primarily intended to help a child learn to tie shoes. While this skill is of value to a handicapped child, the primary purpose of the present invention is the therapy that the learning process offers.

The present invention is used to help autistic and other special needs children focus on a task, help them with manual dexterity, allow for a sense of accomplishment and lastly provide them with a life skill of being able to tie their own shoes.

The shoes pointing in different directions offers the child a broader scope to the task in order to help them learn to help themselves and to be able to offer help to someone else.

The two sets of laces on one shoe offers color contrast to help the child differentiate between the strings. The rubber bands on the laces provide a targets for the child in the tying process. One rubber band is a target for where to hold or where to push through the string. There could certainly be other means to provide the colored target on the string.

Generally one of the laces will be while the other lace will have a preselected color. There are two different colored strings on one pair of shoes for a reason. A challenged child or a person with head trauma will become discouraged if the laces are untied immediately after they have performed the task. Having four sets of strings on the two shoes allows them to make repeated attempts without taking apart what they have done or accomplished. It takes many times for these children to remember how to tie the laces. Once they have mastered the task one set of laces can be removed.

The bands are colored rubber bands used in the apparatus. The use of colored strings helps the child distinguish between the two strings while manipulating the strings. One color band they hold in the bow position, while wrapping the other as they make the bow they are working with the other colored band.

Challenged children or adults with severe learning disabilities may only learn in a specific way. They may not be able to tie the string in any other orientation than the one they learned. The multiple orientations of the shoes broadens their understanding of the task. They have to learn both directions.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus for providing a learning tool for teaching children with special needs the art of tying shoes as a means of therapy that a learning process offers, said apparatus comprising:
(a) a housing member having a predetermined shape, a predetermined size and formed of a predetermined material;
(b) a pair of shoes disposed on an upper surface of said housing member in a predetermined orientation; and
(c) two sets of laces disposed on each shoe of said pair of shoes in a predetermined manner, said each of said two sets of laces having a different predetermined color.

2. The apparatus, according to claim 1, wherein said laces further include rubber bands disposed on each lace of said two sets of laces at predetermined positions as a target for such child to grasp said lace.

3. The apparatus, according to claim 1, wherein said two sets of laces provide a means of repeating such art of tying without undoing a completed task.

4. The apparatus, according to claim 1, wherein said housing member includes a substantially flat base member, a pair of triangular shaped side members engageable on a bottom portion thereof with an upper surface of said substantially flat base member and a top member is affixed to said triangular shaped side members so that said top portion is set at a predetermined angle.

5. The apparatus, according to claim 4, wherein said predetermined material is selected from one of wood and plastic.

6. The apparatus, according to claim 4, wherein said housing member further includes an open compartment disposed between an underside of said top portion, inside surfaces of said side members and an upper surface of said base member.

7. The apparatus, according to claim 6, wherein said open compartment is used to store one of prizes and awards for accomplishing a given task.

8. The apparatus, according to claim 4, wherein said substantially flat base member extends beyond said triangular shaped side members.

9. The apparatus, according to claim 8, wherein said apparatus further includes a pair of clamps for securing said apparatus to a predetermined object.

10. The apparatus, according to claim 9, wherein said clamps are engageable with a portion of said substantially flat base member that extends beyond said triangular shaped side members.

11. The apparatus, according to claim 1, wherein said each lace of said two sets of laces further include rubber bands disposed at predetermined positions on said each lace for at least assisting such special needs child in knowing where to grasp said each lace.

12. The apparatus, according to claim 1, wherein said rubber bands are formed with a predetermined color.
